(19) United States
(12) Patent Application Publication
(10) Pub. No.: US 2026/0356431 A1
(43) Pub. Date: Nov. 12, 2026

(54) BODY STRUCTURE FOR A VEHICLE AND METHOD FOR MANUFACTURING VEHICLES

(71) Applicant: Volkswagen Aktiengesellschaft, Wolfsburg (DE)

(72) Inventor: Eike SCHUPPERT, Velpke (DE)

(73) Assignee: Volkswagen Aktiengesellschaft, Wolfsburg (DE)

(21) Appl. No.: 19/714,791

(22) Filed: Jun. 22, 2026

Related U.S. Application Data
(63) Continuation of application No. PCT/EP2024/081362, filed on Nov. 6, 2024.

(30) Foreign Application Priority Data
Dec. 20, 2023 (DE) 10 2023 213 063.7

(51) Int. Cl. B62D 21/11; B60G 13/00

(52) U.S. Cl. CPC B62D 21/11; B60G 13/003; B60G 2204/128

(57) ABSTRACT

A body structure for the front end of a two-track vehicle, comprising a large cast component with at least one suspension strut mount, which has a suspension strut tower on which an upper end of a suspension strut, in particular a tower bearing of the suspension strut, is supportable. The suspension strut tower is a sheet metal insert that is connected to the suspension strut mount, which is part of the large cast component, in a composite joint such as an adhesive joint.

This nonprovisional application is a continuation of International Application No. PCT/EP2024/081362, which was filed on Nov. 6, 2024, and which claims priority to German Patent Application No. 10 2023 213 063.7, which was filed in Germany on Dec. 20, 2023, and which are both herein incorporated by reference.

### BACKGROUND OF THE INVENTION

### Field of the Invention

The invention relates to a body structure for the front end of a two-track vehicle, and to a method for manufacturing vehicles.

### Description of the Background Art

Manufacturing a body structure as a large cast component can reduce vehicle weight compared to conventional manufacturing methods, thus improving vehicle performance and fuel efficiency. Furthermore, the large cast component may be structurally more stable and provide improved strength, which may result in increased vehicle safety.

A generic body structure for the front end of a vehicle comprises a large cast component with at least one suspension strut mount. This is formed with a suspension strut tower on which an upper end of a suspension strut, in particular a suspension strut mount bearing, is supportable.

In the manufacture of vehicle models having different axle geometries, i.e., different track widths and/or different body heights, a separate casting tool must be provided for each of these vehicle models in order to cast a large cast component that is adapted to the desired axle geometry. This involves significant tooling and manufacturing effort.

DE 10 2010 013 842 A1, which is incorporated herein by reference, relates to a body structure of a motor vehicle having at least one suspension strut mount. In an at least partially modular body structure, a first suspension strut mount module having a specific tower design and connecting elements of a specific connection geometry is available for connection to associated body structure elements. Furthermore, at least one additional suspension strut mount module having the same connection geometry but a different tower design is available for assembly, allowing for a variation of the body structure with regard to the suspension strut position.

A support structure for a motor vehicle body is known from DE 198 47 876 A1, which is incorporated herein by reference. This support structure has a side member, and a suspension strut support which is connectable to the side member and which includes a suspension strut mount that is formed in one piece with the side member. The suspension strut support is designed as a cast part.

### SUMMARY OF THE INVENTION

It is therefore an object of the present invention is to provide a body structure for the front end of a two-track vehicle and a method for manufacturing vehicles that can be manufactured with reduced tooling and manufacturing effort.

In an example, the invention relates to a body structure for the front end of a two-track vehicle. The body structure is provided as a large cast component having at least one suspension strut mount, which has a suspension strut tower on which an upper end of a suspension strut is supportable, in particular via a tower bearing. The suspension strut tower is not a single-material, one-piece component of the large cast component. Rather, the suspension strut tower is formed as a sheet metal insert that is separate from the large cast component. The sheet metal insert is connectable to the suspension strut mount, which is a part of the large cast component, using a composite joint such as an adhesive joint. The sheet metal insert may be geometrically modified independently of the large cast component to make adjustments to the axle geometry of the vehicle being manufactured. Nevertheless, the suspension strut mount, which is part of the large cast component, remains unchanged. For example, identical large cast components but with different sheet metal inserts may be kept in stock for vehicle models having different axle geometries, thereby reducing the tooling effort in the casting process as well as the production effort in manufacturing the vehicle models, compared to the prior art.

In an example, the suspension strut tower may have a screw-on surface to which the upper end of the suspension strut, i.e. the suspension strut tower bearing, is screwable, preferably in an orientation that is normal, i.e., perpendicular, to the screw-on surface. A suspension strut that is screwed onto the screw-on surface of the suspension strut tower with a normal orientation offers several advantages, namely, simple maintenance, quick replacement of the suspension strut, and increased stability due to the direct fastening to the screw-on surface, which contributes to improved driving stability.

With regard to sufficient component rigidity, the suspension strut mount may have a hollow cylindrical peripheral wall which at the top, in the vertical direction of the vehicle, terminates with a circumferential collar. This collar has a reduced diameter compared to the peripheral wall. The reduced-diameter, circumferential collar increases the dimensional stability of the hollow cylindrical suspension strut mount.

The suspension strut tower, which can be implemented as a sheet metal insert, may be manufactured as a cup-shaped deep-drawn part for cost-effective manufacturing. This part has a profile base from which a circumferential side wall extends upwardly. The circumferential side wall may terminate with an annular shoulder that is larger in diameter than the circumferential side wall, as a result of which the sheet metal insert (i.e., the suspension strut tower) is likewise dimensionally stable and rigid.

In the assembled state, it can be preferable for the large-diameter annular shoulder of the suspension strut tower to engage beneath the reduced-diameter collar of the suspension strut mount. In this case, the collar of the suspension strut mount forms a height stop against which the suspension strut tower, designed as a sheet metal insert, can be brought into contact in a joining direction in the vehicle vertical direction toward the top of the vehicle, preferably with an annular large-surface contact. Such a large-area connection may simplify the assembly process due to the presence of a greater tolerance for misalignment. Furthermore, the large-area connection enables efficient transmission of force between the sheet metal insert and the suspension strut mount, which is part of the large cast component. With regard to a large-surface connection that is as gap-free as possible, it is preferable for the annular shoulder of the suspension strut tower and the collar of the suspension strut mount to be contour-matched. The profile base of the suspension strut tower may provide the screw-on surface for the upper end of the suspension strut, i.e., the tower bearing. In addition, the circumferential collar of the suspension strut mount may delimit a central assembly opening through which the profile base of the suspension strut tower is accessible from above.

In the manufacture of vehicles, there may be a requirement to provide at least two vehicle models, each having a different axle geometry. According to the invention, both vehicle models may be equipped with identical large cast components, but with different sheet metal inserts. Each of these sheet metal inserts is shaped with regard to the desired axle geometry. It is preferred when the annular shoulder contours of the two differently shaped sheet metal inserts are identical to one another in order to achieve a flawless composite joint connection with the collar of the suspension strut mount. In contrast, the profile bases of the two sheet metal inserts that form the screw-on surfaces for the suspension struts may be spatially aligned differently. Depending on the installation of the first or second sheet metal insert, the suspension strut is therefore screwable to the profile base of the respective sheet metal insert at a different suspension strut angle. This allows the two vehicle models to have different body heights and/or different track widths.

For example, the sheet metal insert installed in a first vehicle model may have a flatly oriented profile base, as a result of which the screwed-on suspension strut is positioned more steeply. This results in a reduced track width and/or a higher body height. Conversely, in a second vehicle model, the profile base of the sheet metal insert installed therein may be positioned more steeply. In this case, this results in a larger track width and/or a reduced body height compared to the first vehicle model.

The large cast component may be formed, mirror-inverted with respect to the vehicle central longitudinal plane, on each side of the vehicle with a body side member and a body crossmember. The two body side members may be connected to one another, with a suspension strut mount on each side of the vehicle, made of the same material in a single piece, being integrally formed on the respective body side member.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1 to 3 show different views illustrating the suspension strut mount according to the invention.

### DETAILED DESCRIPTION

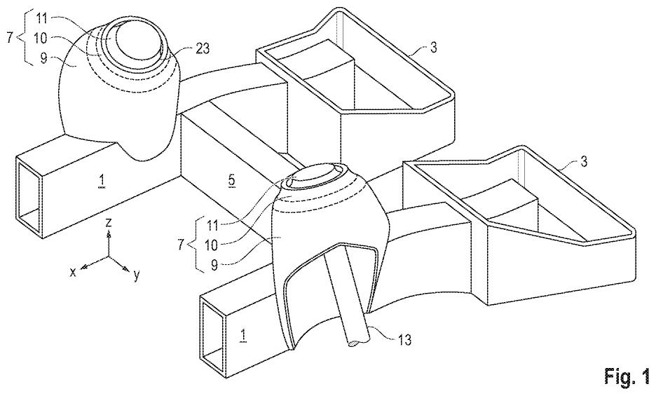

FIG. 1 shows a body structure for the front end of a two-track vehicle. The body structure is designed as a large cast component that has a body side member 1 on each side of the vehicle with respect to a vehicle center longitudinal plane. Toward the rear in the vehicle longitudinal direction x, the body side member 1 merges into a battery or vehicle floor connection 3. The two body side members 1 are connected to one another via a body crossmember 5. In addition, a suspension strut mount 7 is integrally formed on each of the two body side members 1. The battery or vehicle floor connection 3, the body crossmember 5, and the two suspension strut mounts 7, together with the two body side members 1, are part of the large cast component, which is mirror-inverted with respect to the vehicle central longitudinal plane.

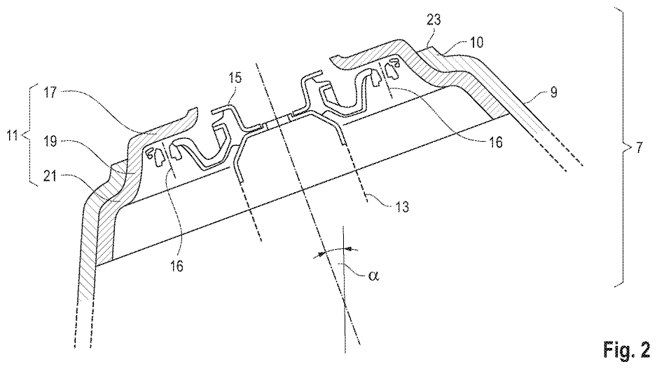

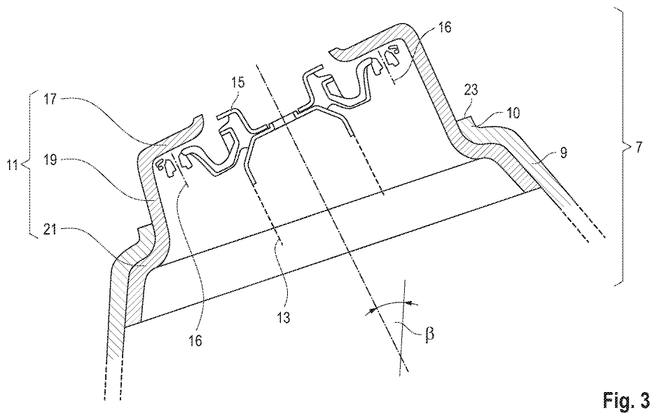

Each of the two suspension strut mounts 7 is made up of a hollow cylindrical peripheral wall 9 which, at the top in the vehicle vertical direction z, terminates with a circumferential collar 10. This collar has a reduced diameter compared to the hollow cylindrical peripheral wall 9. The suspension strut mount 7 also has a suspension strut tower 11 designed as a sheet metal insert, on which a suspension strut 13 is supportable via a tower bearing 15 (FIG. 2 or 3). The suspension strut tower 11 is connected to the suspension strut mount 7 in a composite joint such as an adhesive joint.

For a stable connection, the suspension strut tower 11 is implemented as a cup-shaped, deep-drawn part with a profile base 17. A circumferential side wall 19 extends upwardly from this suspension strut tower. The circumferential side wall 19 terminates with an expanded annular shoulder 21. This annular shoulder has a larger diameter than the circumferential side wall 19 of the suspension strut tower 11. During assembly, the suspension strut tower 11, which is designed as a sheet metal insert, is guided upwardly through the hollow cylindrical peripheral wall 9 of the suspension strut mount 7, in a joining direction in the vehicle vertical direction z, until the large-diameter annular shoulder 21 of the suspension strut tower 11 comes into annular contact with the small-diameter collar 10 of the suspension strut mount 7. In the assembled state, the large-diameter annular shoulder 21 of the suspension strut tower 11 thus engages beneath the reduced-diameter collar 10 of the suspension strut mount 7. The composite joint thus formed between the suspension strut tower 11 and the suspension strut mount 7 is subjected only to pressure, as a result of which high joint strength can be achieved.

As further shown in FIG. 2, the profile base 17 of the suspension strut tower 11 provides a screw-on surface to which the tower bearing 15 of the suspension strut 13 is screwable via screw connections 16. The circumferential collar 10 of the suspension strut mount 7 delimits a central assembly opening 23 through which the profile base 17 of the suspension strut tower 11 is accessible from above.

A key part of the invention relates to a method for manufacturing at least two vehicle models, each having different axle geometries. According to the invention, identical large cast components may be used for the two vehicle models, but with suspension strut towers 11 that are specifically adapted to the respective axle geometry, as indicated in FIGS. 2 and 3. According to FIG. 2, a first sheet metal insert 11 is installed as a suspension strut tower in the hollow cylindrical suspension strut mount 7, the profile base 17 of which is flatly oriented. The suspension strut 13, which is screwed normal to the profile base 17, is therefore positioned comparatively upright with a steep suspension strut angle α, resulting in a correspondingly increased body height and a reduced track width.

Conversely, in FIG. 3, a second sheet metal insert 11 is installed in the hollow cylindrical suspension strut mount 7, the profile base 17 of which is more steeply oriented compared to FIG. 2. The suspension strut 13, which is screwed normal to the profile base 17, is therefore positioned with a comparatively flat suspension strut angle β, resulting in a correspondingly reduced body height and an increased track width.

As is apparent from FIGS. 2 and 3, the annular shoulders 21 of the two differently designed suspension strut towers 11 and the respective associated collar 10 of the suspension strut mount 7 are contour-matched to one another in order to achieve the largest possible contact area. Furthermore, FIGS. 2 and 3 show that the annular shoulder contours of the two sheet metal inserts 11 are of identical design, while only the profile bases 17 of the two sheet metal inserts 11 are spatially aligned differently.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A body structure for the front end of a two-track vehicle, the body structure comprising:
a large cast component; and
at least one suspension strut mount, which has a suspension strut tower on which an upper end of a suspension strut or a tower bearing of the suspension strut is supportable,
wherein the suspension strut tower is a sheet metal insert that is connected to the suspension strut mount, which is part of the large cast component, in a composite joint or an adhesive joint.

2. The body structure according to claim 1, wherein the suspension strut tower has a screw-on surface to which the upper end of the suspension strut is screwable or in an orientation that is normal or perpendicular to the screw-on surface.

3. The body structure according to claim 1, wherein the suspension strut mount is made up of a hollow cylindrical peripheral wall that terminates at the top in the vertical direction of the vehicle, and wherein the suspension strut mount comprises a circumferential collar having a reduced diameter compared to the hollow cylindrical peripheral wall.

4. The body structure according to claim 1, wherein the suspension strut tower has a cup-shaped, deep-drawn part having a profile base from which a circumferential side wall extends upwardly, the circumferential side wall terminating with an annular shoulder that is larger in diameter than the circumferential side wall, and wherein the profile base forms the screw-on surface for the suspension strut.

5. The body structure according to claim 4, wherein, in the assembled state, the large-diameter annular shoulder of the suspension strut tower engages beneath the reduced-diameter collar of the suspension strut mount, and wherein the collar of the suspension strut mount forms a height stop against which the suspension strut tower, designed as a sheet metal insert, is adapted to be brought into annular contact in a joining direction in the vehicle vertical direction towards the top of the vehicle, and/or wherein, in the installed position, the composite joint between the reduced-diameter collar of the suspension strut mount and the large-diameter annular shoulder of the suspension strut tower is essentially subjected to pressure.

6. The body structure according to claim 5, wherein the annular shoulder of the suspension strut tower and the collar of the suspension strut mount are contour-matched to one another in order to provide a large-area contact.

7. The body structure according to claim 4, wherein the circumferential collar of the suspension strut mount delimits a central assembly opening through which the profile base of the suspension strut tower is accessible from above.

8. The body structure according to claim 1, wherein, in order to provide vehicles with different axle geometries, at least one first sheet metal insert and one second sheet metal insert having different component geometries are be kept in stock, and wherein the annular shoulder contours of the two sheet metal inserts are of identical construction, while the profile bases of the two sheet metal inserts are spatially aligned differently, so that, depending on the installation of the first or the second sheet metal insert, the suspension struts are screwable to the profile base of the respective sheet metal insert at different suspension strut angles as a result of which vehicles having varying body heights and/or varying track widths are manufacturable.

9. The body structure according to claim 1, wherein the large cast component is formed, mirror-inverted with respect to the vehicle center longitudinal plane, on each side of the vehicle with a body side member, and further comprising a body crossmember that connects the two body side members to one another, and/or wherein the suspension strut mount, made of the same material in a single piece, is integrally formed on the respective body side member.

10. A method for manufacturing vehicles having different axle geometries, wherein the vehicles in each case have a body structure according to claim 1.
